(19) United States
(12) Patent Application Publication
(10) Pub. No.: US 2004/0210927 A1
(43) Pub. Date: Oct. 21, 2004

(54) Multicasting systems using distributed user authentication

(76) Inventors: Charles C. Bahr, Watchung, NJ (US); Hungkei Keith Chow, Scotch Plains, NJ (US); Marcus K. Weldon, Summit, NJ (US)

Correspondence Address: Law Office of Peter V.D. Wilde, 301 East Landing, Williamsburg, VA, 23185, US

(21) Appl. No.: 10/419,564

(22) Filed: Apr. 21, 2003

(51) Int. Cl. H04N 7/173

(52) U.S. Cl. 725/30; 725/87; 725/93

(57) ABSTRACT

The specification describes a multicast system wherein user authentication is performed at a specially provided remote node in the multicast system. This reduces incoming traffic to the primary multicast server, thereby reducing latency in the system.

### FIELD OF THE INVENTION

This invention relates to multicasting systems, and more particularly, methods and systems for user authentication in these systems.

### BACKGROUND OF THE INVENTION

The availability of the Internet, and its ability to access very large numbers of computers, has spawned a wide variety of Internet services. These include services that provide live programming as well as services that transmit stored video data in a variety of formats such as MPEG, AVI, RMV, RealPlayer, etc., images, multiparty messaging, etc. Live programming services include teleconferencing, live video events such as sporting events, concerts, etc. Stored program services include content such as movies, TV programming archives, video clips, or TieVo-like services. In many cases, the service is provided to many users simultaneously. In those cases the volume of network traffic required to serve those users can be minimized using multicasting.

Multicasting is used in a variety of network environments where information is exchanged using data packets, and wherein the data packets from a main centralized server are routed to many subscribed users. In essence, multicasting allows the main centralized server to send each information packet once for transport over the wider area network, with multicast routers being used to make copies of the program stream for each local user port that has subscribed to the service. In the description below, the main centralized server, where usually the primary information content is stored and where any user authentication occurs, will be referred to as the primary multicast server.

In contrast, the role of the multicast router is to simply replicate multicast streams received from the primary multicast servers, once for every local port on which a request for this stream was (recently) seen. It is possible that the primary multicast server and the multicast router functionality are either collocated or even integrated into the same physical box; however such cases are currently the exception rather than the rule. In most cases the primary multicast server is distinct and remotely located from the local multicast router. In such instances the multicast router does not perform any authentication, although it may perform simple multicast filtering, wherein some local ports may not be permitted to join certain multicast streams, based on rules contained in so-called ‘access control lists’, under the control of the network management system.

Many multicast systems are interactive, i.e. data packets flow from the primary multicast server both to and from the users. In the case where a localmulticast router exists between the primary multicast server and the user, the multicast router monitors user commands to identify a subset of potential users and it either forwards all requests to the primary multicast server for authentication, or, for example, when no authentication is required, it may forward only a single request for a channel on behalf of all attached users. When the requested content is subsequently delivered to the multicast router by the primary multicast server, the multicast router forwards the information packets only to users that are “on-line”, and have signaled demand, at a given time. Packets are not sent to users that have not requested the information. Typically the subset of users, for a given program of information, for example a television broadcast channel, is a small fraction of the total number of subscribers to that service. Thus, using multicasting, the totality of network traffic in the system can be substantially reduced relative to the simple broadcast case. Conceptually, this is made possible by the fact that the user demands and selects programming at the primary multicast server and multicast routers rather than at the user location. That results in a system wherein the only information flowing in the network at a given time is information actually requested. This contrasts with a conventional multi-user system, for example a cable television system, wherein all channels are transmitted to the subscriber location and the channel selection is made at the user end. In this context the important feature of the multicast system is the interactive feature, i.e. the command signals that are initiated by the user and sent to the server.

In typical multicast systems the user initiated command signals serve at least a dual function. They identify both the program information requested, as well as to authenticate the source of the command as a registered subscriber. They may also provide subscriber data, i.e. the class or type of service for which the user is qualified. For simplicity in the following description, it should be assumed that the term authentication data includes both user identity and user subscriber information. (In some systems to be described, those functions may be distributed selectively, but that will be specifically indicated.)

Data transmission comprising the program request may be quite short-lived, for example, when a television channel change is requested. However, the authentication data can substantially increase the complexity of the user command signal. This is especially the case in state of the art systems designed for high security where complex coding or encryption schemes are used. Moreover, the authentication portion of the user command signal may be required each time a change in program content is requested, effectively multiplying the data traffic from the user to the primary multicast server. In periods of high demand for the service, the attachment of authentication data to every user command may itself contribute to overload in the system. Moreover, the authentication process, which takes place at the primary multicast server, involves comparing the authentication data to a look-up table at the primary multicast server to verify the subscriber, as well as, in many systems, to qualify the subscriber for the program selection made by the user command. The propagation of this request from the user to the primary multicast server and the subsequent authentication process adds delay to the execution of the program selection. The delay is a well-known phenomenon, referred to as “latency”. Severe latency, due to high traffic or the complexity of authentication, may be tolerable in some cases, for example, where a single program selection is made and the duration of that selection is relatively long. However, even modest latency (˜1 sec) associated with channel hopping, or with interactive programs, for example, or for peer-to-peer or multiple-peer player games, may be unacceptable.

Problems, like those just mentioned, with authentication in multicast systems have been addressed in a variety of ways. These include reducing the complexity of the authentication signals using coding schemes. One such approach is known as asymmetric MACs (message authentication codes). See R. Canetti, et al., “Multicast Security: A Taxonomy and Some Efficient Constructions”, IEEE INFOCOM '99. Another approach to simplifying authentication involves signing an initial packet in a packet stream, and attaching a sequence code to subsequent packets in the stream. See R. Gennaro et al., “How to sign digital streams”. Advances in Cryptology—CRYPTO '89, 1989. Since each packet identifies a subsequent packet, loss of a packet interrupts the verification, and remaining packets in the stream will be lost. Thus the drawback to this scheme is that it assumes 100% data integrity. Several authentication simplifying schemes have been proposed which require many packets to be transmitted in a stream or block, and the authentication code for each packet includes block data. See C. Wong et al. “Digital Signatures for Flows and Multicasts”, Proceedings IEEE ICNP '98, Austin, Tex., October 1998. In these schemes, using packet streams, requires delaying the transmission to allow the packet stream to be assembled. All of these approaches share the common goal of simplifying and improving the reliability of the authentication process at the primary multicast server.

### BRIEF STATEMENT OF THE INVENTION

We have designed a multicast system that takes an entirely different approach to the user authentication problem. In our system the authentication function is disintegrated from the primary multicast server and distributed downstream (with respect to the primary multicast server). Nodes are added to the network between the user and the primary multicast server. These nodes have the potential for performing a variety of adjunct network functions, but in each case all, or at least part, of the authentication process is performed at the node. To the extent that the authentication process is distributed (all or part) the portion of the traffic to the primary multicast server that comprises authentication data is reduced or eliminated.

### BRIEF DESCRIPTION OF THE DRAWING

The invention may be better understood when considered in conjunction with the drawing in which:

FIG. 1 is a schematic diagram of a conventional multicast system with user authentication performed at the primary multicast server, which also incorporates the multicast router functionality; and

FIGS. 2-4 are schematic diagrams of a variety of embodiments of multicast system according to the invention in all of which a user authentication function is performed at satellite servers.

### DETAILED DESCRIPTION OF THE INVENTION

As will become evident, the use of a distributed user verification system, according to the invention provides a variety of potential advantages. For example, no examination or modification of the user data is required in order to identify the user for authentication purposes. Since users are assumed to be directly attached to the remote nodes, the physical port to which a given subscriber is connected can be used as the sole basis for authentication requests. This eliminates the need to rely on specific ‘fields’ in the data stream (such as the user source data link layer or network layer address). Since this port attribute is completely under the control of the node provider (unlike user data fields), it cannot be spoofed by a rogue user and so no special coding or encryption of the user request is needed in order to verify authenticity. Furthermore, any changes in the user data fields, for example, assignment of a new network layer address, which can be relatively frequent (e.g. every few minutes) does not require a change in the look-up tables for authentication. Both of these factors—the absence of a need for coding/encryption and the independence of user data-field changes—have the potential for greatly decreasing the network load and improving the robustness of the system. Systems which choose to use coding or encryption schemes or the user data fields for authentication may still take advantage of the invention, since the time required for the authentication function, regardless of how it is done, is distributed. For example, if a conventional server processes A authentications in S seconds, a system according to the invention, with N distributed nodes, can process NA authentications in S seconds. Accordingly both issues described earlier, traffic congestion at the server, and latency in the system, are addressed by the invention. In the description below, the remote nodes are referred to as satellite servers.

With the added capabilities of the satellite servers, new system configurations are allowed. In one embodiment (embodiment 1), user command data, comprising authentication data and program selection data, is transmitted from the user to a satellite server. The authentication data is processed at the satellite server. If the authentication data is verified, the program selection data (only) is transmitted to the primary multicast server. In this embodiment all of the program information normally originates at the primary multicast server and the satellite server performs only a routing function for the program information.

In another embodiment (embodiment 2), the authentication process is shared between the satellite server and the primary multicast server. For example, the satellite server may verify just the identity of the purported user, and remaining authentication data (for example subscription information) is transmitted along with program selection data to the primary multicast server.

In another embodiment (embodiment 3), the satellite server stores high demand program information at the satellite server. Both portions of the user command, the authentication data and the program selection data, are processed at the satellite server. If the program information selected is available at that satellite server, the entire transaction is completed at the satellite server. If the program selected is not available at the satellite server, the system functions as in embodiment 1.

Another embodiment (embodiment 4) is adapted for high demand live programming. The program information is broadcast by the primary multicast server to all satellite servers. If the user selects the live broadcast, the authentication function and the program selection function are completed at the satellite server. If the user selects another program, or changes programs, the system functions as described in previous embodiments. In this embodiment, the system is designed for, and is fully compatible with, providing both kinds of services.

In another embodiment (embodiment 5), the satellite server performs the authentication function, and processes the program selection information. If the program selected is in use by another user at that satellite server, the satellite server simply associates the new user with the existing program data stream. The program data may originate either at the satellite server or the primary multicast server.

Other embodiments comprise combinations of those just described. The embodiments just outlined will be described in detail with the aid of the figures.

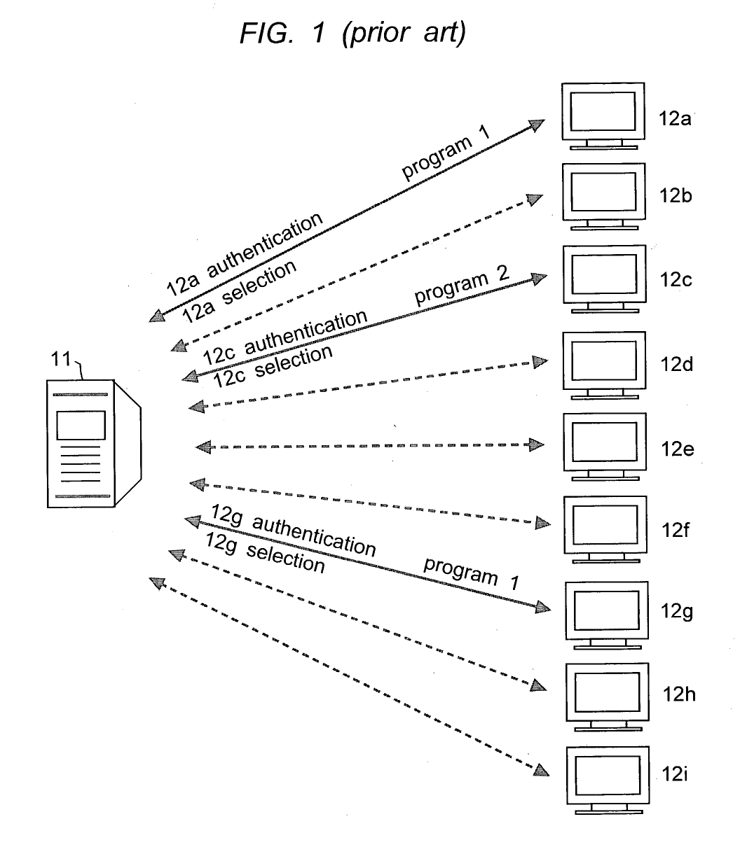

FIG. 1 illustrates a conventional multicast system with a primary multicast server 11, and users denoted 12a-12i. In the illustration there are N users, where N=9. It should be obvious that in a commercial system this number is typically much larger. Two-way communication routes between the users and the primary multicast server are represented by the arrows. A typical use scenario is shown wherein only users 12a, 12c, and 12g are active. Information transferred from the users to the server (referred to below as incoming information) includes both authentication data and selection data. Information from the server to the users (referred to below as outgoing information) comprises the program information selected, as well as, potentially “polling” information used by the primary multicast server to verify the current multicast group memberships. Users 12a and 12g are receiving the same data, which may for example, be a live video channel. User 12c is receiving different programming, which may be another video channel, or may be a program provided on demand, e.g. a selection from a video library. It will be understood that the illustration shown is but one example of a large number of potential scenarios. However, these all share the common attribute that the information from the users to the servers comprises user authentication data and well as user selection data.

It will also be recognized that, while the amount of outgoing information may be large, it is distributed. Congestion at the user location does not occur. However, traffic comprising incoming information, authentication and selection data, has a relatively high potential for congestion at the primary multicast server whenever a large number of users simultaneously enter user commands in the system.

The standard approach to solving the congestion problem is to build another system, i.e. replicate the system of FIG. 1. In that case the cost and complexity of the overall system is doubled.

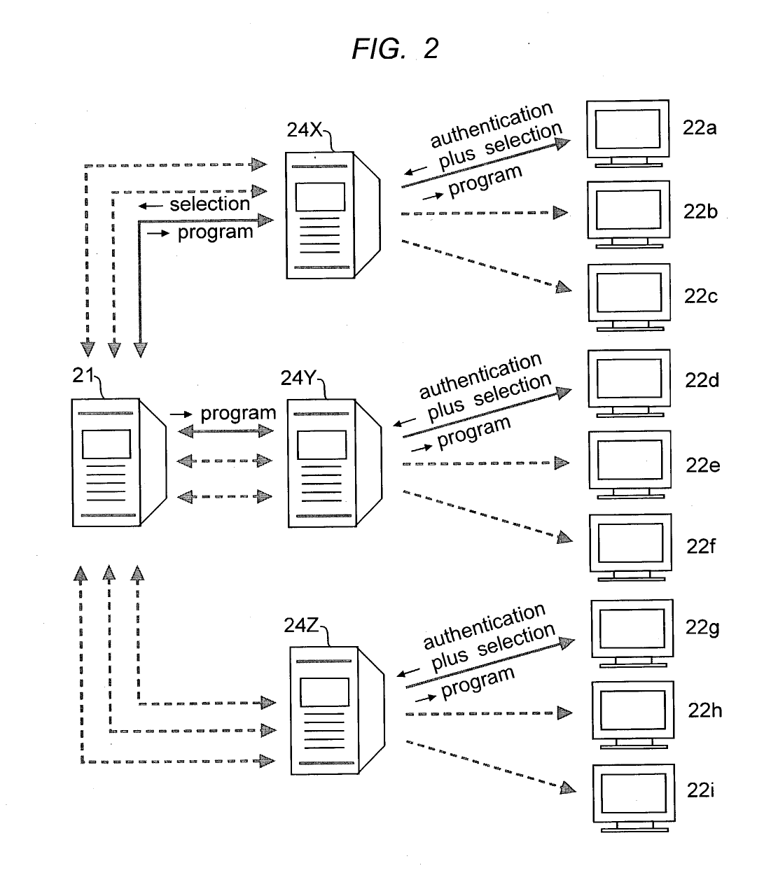

According to the invention, the potential for traffic congestion at the primary multicast server 11, and the attendant latency and other consequences of congestion, are substantially reduced by distributing all or selected portions of the incoming traffic to satellite servers. This is illustrated in FIG. 2 where the primary multicast server 21 is connected to satellite servers 24X, 24Y, and 24Z. It should be pointed out at the outset that, for convenience, each of the satellite servers in FIG. 2 is shown as performing a different function, i.e. a different embodiment of the invention. In the preferred implementation of the invention all of the satellite servers perform a combination of the functions shown in FIG. 2. In other embodiments, all satellite servers in the system may function the same as satellite server 24X, or satellite server 24Y, or satellite server 24Z. Alternatively, the system may be designed strictly as shown, with different servers performing different (customized) functions. However, in all cases the satellite servers will, at a minimum, perform the authentication function. Therefore, at least that portion of the system traffic is distributed, and the incoming information load on the primary multicast server reduced.

Server 24X as shown serves users 22a, 22b, and 22c, and in this embodiment performs only an authentication function. The authentication data plus the selection data is transmitted from user 22a to the satellite server 24X. Satellite server 24X is provided with a lookup table with identity information for users 22a, 22b, and 22c. It may also have subscriber program qualification data for these users stored as well. When a command is received (from user 22a in this illustration) the satellite server processes the user command data and attempts to verify the user. This is implemented using standard logic comparator integrated circuits, as is well known in the art. If there is no match, the satellite server performs an appropriate response, for example, ignores the command or returns an error message. If there is a match, the satellite server forwards the program selection command to the primary multicast server, where the program selection data is processed and suitable response in the form of outgoing program information is provided. The primary multicast server may simply connect server 24X to an existing stream of packets having the program content selected, when that program is live and in use by other users. Or the primary multicast server may originate a new packet stream if the selection is a program not in current use by one or more other users.

In the figure, solid lines indicate lines carrying the traffic discussed here. The dashed lines indicate lines serving inactive users. The number of lines or channels required in the system of FIG. 1 is typically the same as the number of users. These may comprise optical fibers, and may be bundled in a single cable that extends from a group of users to the primary multicast server. They may comprise channels multiplexed on a single optical fiber. However, if the system of FIG. 1 is a point-to-point system, the system architecture is such that the input bandwidth of the primary multicast server should be sufficient to serve all users simultaneously, i.e. it is designed for maximum use. It is possible that the processing capacity of the primary multicast server could be designed only for typical (not maximum) use, but the fact remains that if the input bandwidth required per user is B, and there are N users in the system, N ports of B bandwidth always have to be provisioned on the primary multicast server. Thus there is the potential for many ports on the primary multicast server to be inactive, at any given time, in the point-to-point system of FIG. 1.

However, the systems of the invention have the capability of substantially reducing the primary multicast server input bandwidth and the number of input ports. The satellite servers will still have N ports of B bandwidth, the same as in FIG. 1. However, the transmission between the satellite server and the primary multicast server may have a fraction of that total bandwidth. This fraction can be aggregated onto fewer links, requiring fewer connections between the primary multicast server and the satellite servers, and fewer input ports on the primary multicast server, since that portion of the system may be designed for anticipated demand, not full demand. It is practical, using the distributed system of the invention, to have X links (where X<N) of the same bandwidth B connected between satellite servers and the primary multicast server, due to this advantage. It is also practical to have X/Y links of higher bandwidth BY, to further reduce the number of input ports on the primary multicast server.

Thus although FIG. 2 shows three information channels between the primary multicast server and the satellite servers, that number may be reduced substantially.

The potential saving in the number of connections between the primary multicast server and the satellite servers just described applies to the case where the primary multicast server and the satellite servers are co-located, as well as to the cases where the satellite servers are remotely located, i.e. they are substantially closer to the user groups than the primary multicast server. In the latter case there is another potential economy attendant to the invention; a reduction in the number of connection-kilometers. That is to say, the quantity of connecting cable (copper or fiber) required to be purchased and deployed can be substantially reduced by locating the satellite servers remote from the primary multicast server. While this feature may therefore be desirable in terms of reducing system cost, other considerations, for example, maintenance, may indicate other arrangements. Thus it is not a requirement of the invention that the satellite servers be located remote from the primary multicast server.

Referring again to FIG. 2, satellite server 24Y is shown operating in a different mode, representing another embodiment. As indicated earlier, in the preferred form of the invention, the satellite servers are designed to implement more than one function. For example, server 24Y may function in each of the configurations shown in FIG. 2. In the configuration actually shown for server 24Y, it performs both the authentication function and the program selection function. The program in this case is provided from the primary multicast server without demand, i.e. it is a live (in the broadcast sense) program and is broadcast non-selectively to all satellite servers. This would be done for a program in wide demand, for example, a popular TV channel or a pay-per-view sporting event. That mode of operation would normally be coded into the user command processor at the satellite server. Note that the operation of the user command processor at the satellite server can be programmed from the primary multicast server to accommodate program changes or new offerings.

Another function that can be distributed using the satellite servers of the invention, and where the transaction is completed without the primary multicast server, is when a user requests a program that is already being provided to another user of a given satellite server. Since the satellite server has the capacity to authenticate the user and process the program request, the satellite server connects the user to the data stream already being transmitted to the previously connected user. With a large number of users, this would be a common occurrence. Thus a very substantial saving in system overhead can be expected when the satellite servers operate in this mode.

Satellite server 24Z is shown operating in a mode where the entire transaction occurs between the user and the satellite server. This could take the form of a video library, or stored TV programming, directly accessible to the satellite server. However, the system is designed so that additional operating modes, for example the operating modes of satellite servers 24X and 24Y, are also available at satellite server 24Z.

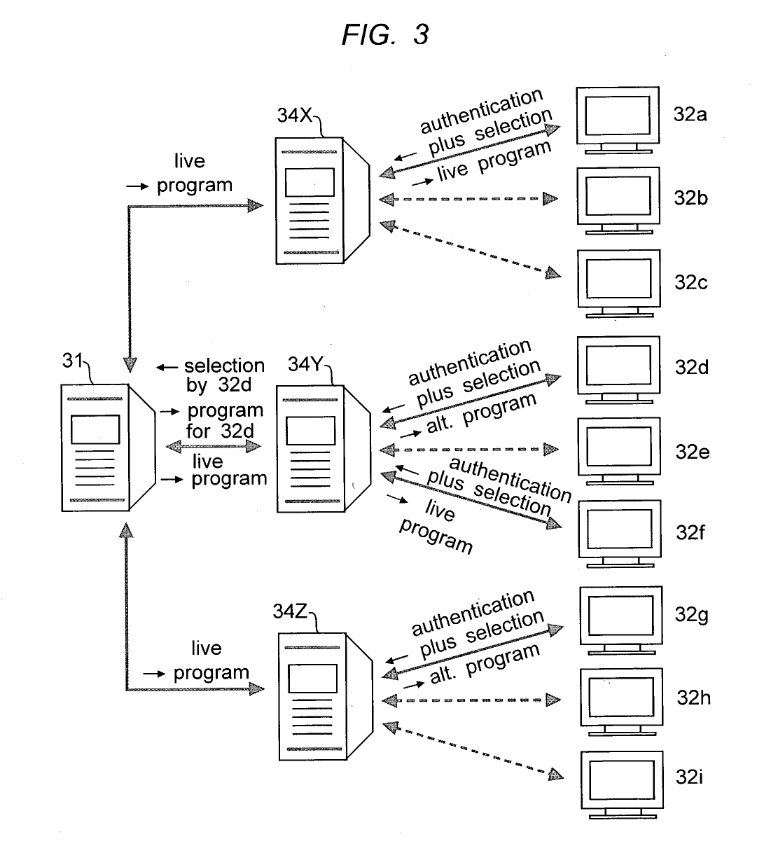

The embodiment just described is a preferred embodiment of the invention and is shown in FIG. 3. Each of the servers 34X, 34Y, and 34Z have multiple functionality as described above. The multicast system of FIG. 3 is intended to illustrate the combination of broadcast programming (non-demand programming) from the primary multicast server 31 to each of the satellite servers while at the same time accommodating selected programming. In FIG. 3 a single line is shown between the primary multicast server 31 and the satellite servers, which indicates that multiple program channels are on that line or that multiple signals are multiplexed on one or more channels. In the illustration shown, a live program is broadcast to all satellite servers. Users 32a and 32f have selected that program locally, i.e. without command to the primary multicast server. User 32d has selected another program, using the same mode used by user 22a in FIG. 2.

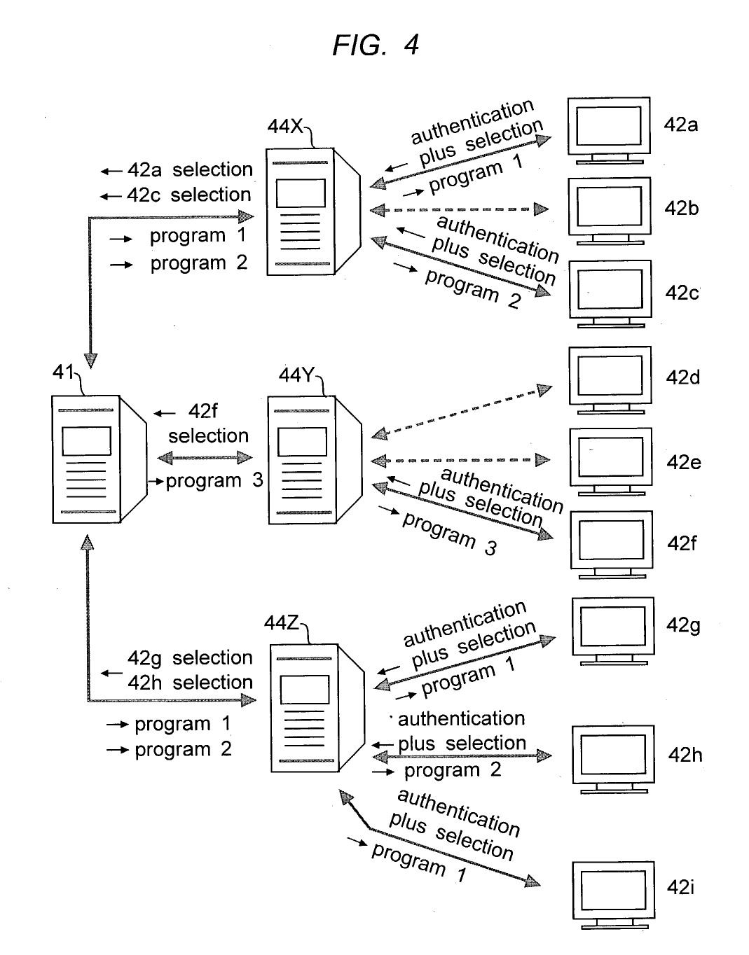

FIG. 4 represents another preferred embodiment of the invention. In this illustration, users 42a, 42c, 42f, 42g and 42i are active. Users 42a and 42c are served by satellite server 44X. Each of these users has selected a different program, and each has their selection data transmitted to primary multicast server 41 (authentication having already been performed at the satellite server). The outgoing information contains programs 1 and 2 as shown. Satellite server 44Y is providing user 42d a third program selection in the same manner. Satellite server 44Z has three active users, but two of them, users 42g and 42i, have selected the same program. Assume that user 42i is the second user on line to request program 1. Satellite server processes that request and determines that program 1 is already being provided to user 42g. Thus user 42i is simply added to the list of users associated with that packet stream. The incoming information to the primary multicast server consequently omits a selection from user 42i. While that single saving in data transmission appears modest in this illustration, it can be anticipated that such an occurrence can be commonplace for popular programming, and when it is recalled that the satellite server 44Z serves many users.

It is envisioned that the satellite servers will normally be designed with common functionality. However, a system can be designed where the satellite servers are each tailored to specific user criteria. For example, when a user subscribes, that user may be connected to a specific satellite server that is customized for the subscriber's programs. In that case the subscriber data may be eliminated from the packet data. If suitable switching networks are provided between satellite servers, connection to customized satellite servers may be made, or changed, from the primary multicast server.

As suggested in FIG. 2, more than one transmission channel may connect the satellite servers and the primary multicast server. This allows the satellite servers to select a transmission line depending on traffic conditions, so as to equalize traffic over the network. Switching capability between satellite servers, as just mentioned, can provide an added benefit.

As mentioned earlier, the authentication data may comprise both user subscription data as well as user identity data. In yet another modification of the invention, the satellite servers may be designed to verify only the user identity, and the primary multicast server processes and responds to the subscriber qualification data. While this modification may not be a preferred choice (it would appear to under utilize the satellite servers) it does illustrate the large number of options that are available when multiple system functions can be allocated between multiple system units. Another option is to use the satellite servers to quantify and store the requests of the users for the purpose of, for example, providing billing information or quantifying the number of viewers of a given program feature at a given time.

Reference herein, and in the appended claims, to users or user stations refers to the instrumentality that may be located at a user's premises. That instrumentality typically provides the codes for the authentication of that user station, and the data for the program selection. Normally that instrumentality will comprise a computer, but may also comprise a video receiver. It also may include a so-called “box”, or other hardware means, or a stored program, or other software means, provided by the multicast service entity. A means for transmitting selection and authentication data from the user station to a satellite server may comprise a transmission line (either optical or electrical), or a wireless link, between the user station and the satellite server.

Various additional modifications of this invention will occur to those skilled in the art. All deviations from the specific teachings of this specification that basically rely on the principles and their equivalents through which the art has been advanced are properly considered within the scope of the invention as described and claimed.

1. A method for multicasting selected program information from a primary multicast server simultaneously to multiple user stations wherein user station selection data and user station authentication data is provided, the steps comprising,
a. comparing, at a first satellite server, first user station authentication data with data stored at the first satellite server to verify the first user station,
b. if verification results, transmitting first user station selection data from the first satellite server to the primary multicast server, and
c. transmitting program information from the primary multicast server to the first user station in response to the first user station selection data.

2. The method of claim 1 including the additional steps of:
d. comparing, at the first satellite server, second user station authentication data with data stored at the first satellite server to verify a second user station,
e. if verification results, transmitting second user station selection data from the first satellite server to the primary multicast server, and
f. transmitting program information from the primary multicast server to the second user station in response to the second user selection data.

3. The method of claim 2 wherein program information is provided at the first satellite server.

4. The method of claim 3 including the steps of:
g. comparing, at the first satellite server, third user station authentication data with data stored at the first satellite server to verify a third user station,
h. if verification results, transmitting program information from the first satellite server to the third user station in response to third user station selection data.

5. The method of claim 2 further including the steps of
g. comparing, at a second satellite server, third user station authentication data with data stored at the first satellite server to verify the third user station,
h. if verification results, transmitting third user station selection data from the second satellite server to the primary multicast server, and
j. transmitting program information from the primary multicast server to the third user station in response to the third user selection data.

6. A method for multicasting selected program information from a primary multicast server simultaneously to multiple user stations wherein user station selection data and user station authentication data is provided, the steps comprising,
a. transmitting first program information from a primary multicast server simultaneously to a first and a second satellite servers,
b. comparing, at the first satellite server, first user station authentication data with data stored at the first satellite server to verify the first user station,
c. if verification results, transmitting the first program information from the first satellite server to the first user station in response to first user station selection data,
d. comparing, at the second satellite server, second user authentication data with data stored at the second satellite server to verify the second user station,
e. if verification results, transmitting the first program information from the second satellite server to the second user station in response to second user station selection data.

7. The method of claim 6 including the additional steps of:
f. comparing, at the first satellite server, third user authentication data with data stored at the first satellite server to verify the third user station,
g. if verification results, transmitting third user station selection data from the first satellite server to the main server, and
h. transmitting program information from the primary multicast server to the third user station in response to the third user station selection data.

8. A method for multicasting selected program information from a primary multicast server simultaneously to multiple user stations wherein user station selection data and user station authentication data is provided, the steps comprising,
a. comparing, at the first satellite server, first user station authentication data with data stored to verify the first user station,
b. if verification results, transmitting first user station selection data from the first satellite server to the primary multicast server, the first user station selection data identifying first program information,
c. transmitting program information from the primary multicast server to the first user station in response to the first user station selection data using a first information stream,
d. comparing, at the first satellite server, second user station authentication data with data stored to verify the second user station,
e. if verification results, processing second user station selection data at the satellite server and transmitting the first information stream to the second user station.

9. A multicast system wherein selected program information is transmitted from a primary multicast server simultaneously to multiple user stations and wherein user station selection data and user station authentication data is provided, comprising;
a. a first satellite server connected to a primary multicast server,
b. a second satellite server connected to the primary multicast server,
c. means for transmitting user station command data from a first and second user station to the first and second satellite servers respectively, said user station command data comprising user station selection data and user station authentication data,
d. verification means located at the first and second satellite servers for processing the user station authentication data and provide user station verification,
g. means responsive to the verification means for transmitting the user station selection data from the satellite servers to the primary multicast server,
h. means at the primary multicast server for processing the user station selection data and
j. means for transmitting program information from the primary multicast server to the satellite servers in response to the user station selection data.

10. The system of claim 9 further including comparator means for comparing the user station authentication data with data stored at the satellite servers to verify the user stations.

11. The system of claim 10 further including means for storing program information at the satellite servers.

12. The system of claim 11 further including:
k. means for transmitting third user station selection data and third user station authentication data to the first satellite server,
l. verification means for comparing the third user station authentication data with data stored at the first satellite server to verify the third user station,
m. means responsive to the verification means for transmitting program information from the first satellite server to the third user station in response to the third user station selection data.

13. A system for multicasting selected program information from a primary multicast server simultaneously to multiple user stations wherein user station selection data and user station authentication data is provided, the steps comprising,
a. means for transmitting first user station selection data and first user station authentication data to a first satellite server,
b. means for transmitting second user station selection data and second user station authentication data to a second satellite server,
c. means transmitting first program information from a primary multicast server simultaneously to the first and second satellite servers,
d. verification means for comparing the first user station authentication data with data stored at the first satellite server to verify the first user station,
e. means responsive to the verification means for transmitting the first program information from the first satellite server to the first user station in response to the first user station selection data,
f. verification means for comparing the second user station authentication data with data stored at the second satellite server to verify the second user station,
g. means responsive to the verification means for transmitting the first program information from the second satellite server to the second user station in response to the second user station selection data.

14. The system of claim 13 further including:
h. means for transmitting third user station selection data and third user station authentication data to the first satellite server,
j. verification means for comparing the third user station authentication data with data stored at the first satellite server to verify the third user station,
k. means responsive to the verification means for transmitting the third user station selection data from the first satellite server to the primary multicast server, and
l. means for transmitting program information from the primary multicast server to the third user station in response to the third user station selection data.

15. A system for multicasting selected program information from a primary multicast server simultaneously to multiple users wherein user station selection data and user station authentication data is provided, comprising,
a. means for transmitting first user station selection data and first user station authentication data to a first satellite server, the first user station selection data identifying first program information,
b. verification means for comparing the first user station authentication data with data stored at the first satellite server to verify the first user station,
c. means responsive to the verification means for transmitting the first user station selection data from the first satellite server to the primary multicast server,
d. means for transmitting program information from the primary multicast server to the second user station in response to the first user station selection data.
e. means for transmitting second user station selection data and second user station authentication data to the first satellite server, the second user station selection data identifying the first program information,
f. verification means for comparing the second user station authentication data with data stored at the first satellite server to verify the second user station,
g. means responsive to the verification means for adding the second user station to the information being transmitted to the first user station in response to the second user station selection data.
